(19) United States
(12) Patent Application Publication
(10) Pub. No.: US 2014/0074584 A1
(43) Pub. Date: Mar. 13, 2014

(54) METHODS AND SYSTEMS TO IDENTIFY AND VALIDATE COUPON CODES

(71) Applicant: Gidon Fisher, New York, NY (US)

(72) Inventor: Gidon Fisher, New York, NY (US)

(21) Appl. No.: 13/608,916

(22) Filed: Sep. 10, 2012

(51) Int. Cl. G06Q 30/02

(52) U.S. Cl. 705/14.39

(57) ABSTRACT

Methods and systems are disclosed which facilitate identification and validation of coupon codes. An example system includes a processor to receive a trigger to initiate a coupon code query based at least in part on a website being viewed. The example system includes a validation engine to search and retrieve coupon codes. The example validation engine is to apply one or more identified coupon codes to a target website to determine validity of each identified coupon code. The example processor is to dynamically provide one or more validated coupon codes to a user in conjunction with the website being viewed.

### RELATED APPLICATION

[Not Applicable]

### FIELD OF THE DISCLOSURE

This disclosure relates generally to coupon codes, and, more particularly, to identification and validation of coupon codes.

### BACKGROUND

Coupons have been used by retailers to attract consumers to purchase goods. Use of coupons extends to online retailers as well. Online coupons are referred to as coupon codes, for example. Availability of coupons can make the difference between a customer completing or abandoning a purchase from a merchant.

### BRIEF DESCRIPTION OF THE DRAWINGS

FIG. 1 illustrates an example coupon identification and evaluation system.

FIG. 2 illustrates an example coupon gathering, validation and presentation system to identify and validate online coupon codes.

FIGS. 3A-3B illustrates a flow diagram of an example method to provide coupon codes to a user via one or more of the systems described herein.

FIG. 4 illustrates an example interface indicating a search for valid coupon codes based on user initiation via a browser bookmarklet.

FIG. 5 shows an example coupon code results page.

FIG. 6 shows an example email message including one or more item updates.

FIG. 7 is a block diagram of an example computer capable of executing the instructions of FIG. 3 to implement the systems of FIGS. 1-2 and 4-6.

### DETAILED DESCRIPTION

Overview

Certain examples facilitate an improved shopping and informational experience for consumers online. In brick-and-mortar shopping, consumers are on the look-out for coupons to help decrease or otherwise the cost of their shopping. Coupons can provide an incentive for a consumer to purchase product that he or she may otherwise not purchase at full price, for example.

Consumers face the same dilemma while shopping online. Once they find something they actually want to purchase and add that item to an online “shopping cart”, consumers may waiver. They wonder if the product is actually worth the price on the price tag. With online shopping, consumers may be distracted by the coupon/promotional code field so prominently displayed at checkout. This one moment of hesitation costs ecommerce companies billions of dollars in lost revenue, as eighty (80%) of online shopping carts are abandoned.

Rather than completing a purchase, a user may open another tab in his or her web browser to search for coupons and/or other discounts to see if he or she can lower the price for the item. For example, a user may search for the name of the merchant+“coupon code” to find a coupon website. These websites, however, simply display lists of coupons, many of which have long expired. This exercise therefore becomes one of trial and error. The user is left to literally copy and paste code after code to see if the merchant will accept the code and discount the merchandise.

Coupons or discounts can be made available online in the form of codes (e.g., alphanumeric codes, bar codes, quick response (QR) codes, etc.). Coupons will be referred to herein as coupon codes and can include, but are not limited to, promotional codes, discount codes, key codes, voucher codes, reward codes, and/or other coupon indicators. Coupon codes can provide a discount or incentive such as a percentage discount, dollar amount deducted from the price, free shipping, bonus or additional item, and/or another incentive to encourage consumers to purchase specific products and/or to purchase from specific retailers.

Often, coupon codes have a limited lifespan. Providers, however, typically do not advertise to users when the coupon codes have expired. Thus, a user may not realize a coupon code is no longer valid until he or she is in the process of purchasing a product via a website (e.g., during checkout). The expired or otherwise invalid coupon code fails to provide the user with an incentive or discount, leaving the consumer frustrated, disappointed, or angry.

Brief Description

Certain examples provide a system including a processor to receive a trigger to initiate a coupon code query based at least in part on a website being viewed. The example system includes a validation engine to search and retrieve coupon codes. The example validation engine is to apply one or more identified coupon codes to a target website to determine validity of each identified coupon code. The example processor is to dynamically provide one or more validated coupon codes to a user in conjunction with the website being viewed.

Certain examples provide a method including initiating, based on a trigger, a coupon code query based at least in part on a website being viewed. The example method includes searching for and retrieving one or more coupon codes using a processor. The example method includes applying, using the processor without further user input, one or more identified coupon codes to a target website to determine validity of each identified coupon code. The example method includes dynamically providing one or more validated coupon codes to a user in conjunction with the website being viewed. The example method includes facilitating selection of a validated coupon code to be used with respect to the website being viewed.

Certain examples provide a tangible computer-readable storage medium including computer program instructions which, when executed by a processor, are to implement a method. The example method includes initiating, based on a trigger, a coupon code query based at least in part on a website being viewed. The example method includes searching for and retrieving one or more coupon codes using the processor. The example method includes applying, using the processor without further user input, one or more identified coupon codes to a target website to determine validity of each identified coupon code. The example method includes dynamically providing one or more validated coupon codes to a user in conjunction with the website being viewed. The example method includes facilitating selection of a validated coupon code to be used with respect to the website being viewed.

Example Systems to Identify and Validate Coupon Codes

Certain examples provide an online coupon validator to help reduce or minimize user guessing regarding price or discount of an item for online sale. Certain examples provide an engine to validate online coupon codes in near real-time to provide only valid, working coupon codes back to users.

Certain examples scrape, or search and analyze, a plurality of online (e.g., Web-accessible or Web-based) coupon resources, including aggregators, emailed newsletters and merchant promotions. Results are processed to remove duplicates, clean, and parse meta-data to extract an associated discount, category, merchant, expiration date, etc. Software constructs referred to as robots visit the merchant sites on a daily basis and act as a human shopper would act on the site. For example, in the case of a twenty percent (20%) off outerwear coupon on www.outdoorgear.com, the robot accesses the website, searches for an outerwear item, adds the item to the cart, and then applies the coupon code. Certain examples capture the price of the item before and after applying the coupon code to see if the code was in fact accepted. If the coupon was accepted, the coupon code is isolated and displayed back to participating and/or applicable user(s) as they shop that day on www.outdoorgear.com. This process is then repeated periodically and/or on an otherwise regular rhythm (e.g., thousands of times a day) for each coupon code and merchant site.

Thus, certain examples save users both time and money. Even if no coupon code is available, users are provided with confidence to make a purchase knowing that they are receiving the best deal that they can at the time.

Further, certain examples display coupons code by recognizing a website and/or other content currently being viewed by a user and then determining if any applicable, valid coupon codes exist. If applicable coupon codes exist and are valid, the relevant coupon(s) are displayed to the user (e.g., in conjunction with the user's browser session viewing the online content).

In certain examples, a user can drag and drop an application, browser plugin, or applet, referred to as a bookmarklet, onto her or her Web browser. For example, a bookmarklet is a script (written in JavaScript, for example) that is stored as the uniform resource locator (URL) or other uniform resource indicator (URI) of a bookmark in a web browser or as a hyperlink on a web page. Whether the bookmarklet utility is stored as a bookmark or as a hyperlink, the bookmarklet is designed to add one-click coupon search and validation functionality to a browser or web page. When clicked or otherwise selected, the bookmarklet extracts context information (e.g., website, merchant, category/type, item, user, etc.) from the web browser viewing a web page and performs a search query and/or data extraction to identify relevant coupon code(s) and validate them.

In certain examples, a web browser sees the bookmarklet as a script (such as javascript) and processes a bookmarklet code or indicator string as code (such as JavaScript code) to be executed. The executing script of the bookmarklet has access to the currently viewed webpage, which it may analyze and alter (e.g., to add coupon code(s) to the browser view of the webpage). In certain examples, the bookmarklet script may generate a new page. In certain examples, the bookmarklet script may not instruct the browser to load a new page but to instead run the script against the current webpage content, permitting in-place changes without a page reload.

In certain examples, the bookmarklet can be added to or “installed” with the browser in a variety of ways. For example, a new bookmarklet may be created with a bookmarklet code pasted into a URL destination field for the bookmarklet. As another example, the bookmarklet can be provided as a link to be dragged and dropped onto a bookmark bar or other toolbar of the browser. The bookmarklet can then be run by selecting or otherwise loading the bookmark.

Once the bookmarklet has been placed onto the browser, the application is instantiated as a button, icon, link, etc., viewable on the browser interface. Then, when the user is accessing a website and viewing an item (e.g., a product page visited, general merchant website, etc.), the user can click the bookmarklet to trigger an engine to identify and validate coupons and/or other discounts applicable and valid with respect to the particular item, category of items, website/vendor, etc. If one or more valid coupons/discounts are found, those results are displayed to the user via the browser in conjunction with the item.

For example, a user is shopping a website and looking at a jacket. He or she can click a button to see if there are coupons available and if there are any coupons valid and related to that jacket.

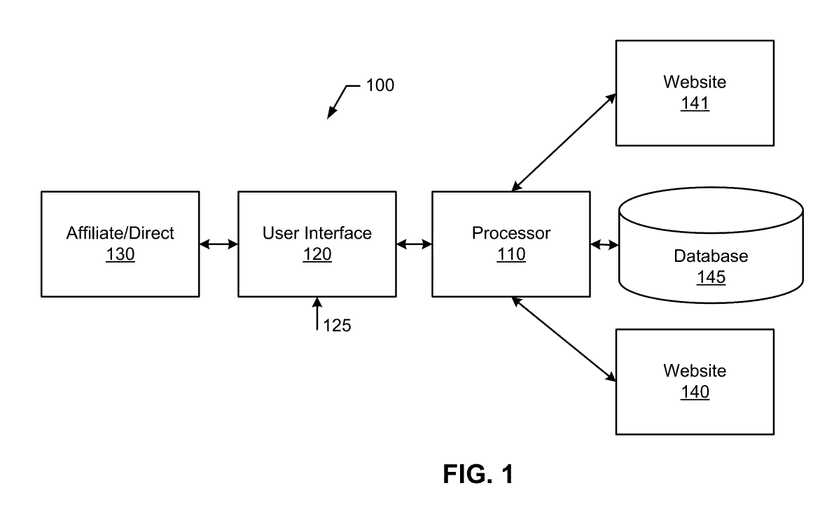

FIG. 1 illustrates an example coupon identification and evaluation system 100. The example system 100 includes a processor 110 and an output, such as a visual output provided to a graphical user interface 120. Via the processor 110, the example system 100 identifies content, such as a merchandise item or service for sale, displayed on the graphical user interface 120 from a webpage 130. The user interface 120 accepts user input 125 to navigate the webpage 130, for example. The processor 110 analyzes the webpage 130 content and identifies content for which one or more coupons may be applicable. The processor 110 then searches one or more websites 140-141 and databases 145-146 to identify coupon(s) and/or other discount code(s) related to the identified content on the viewed webpage 130. Identified coupon code(s) are tested (e.g., by a processor 110 driven test purchase on the webpage 130) to confirm the code(s) are applicable and valid. Applicable, valid coupon and/or other discount code(s) are displayed to the user via the user interface 120.

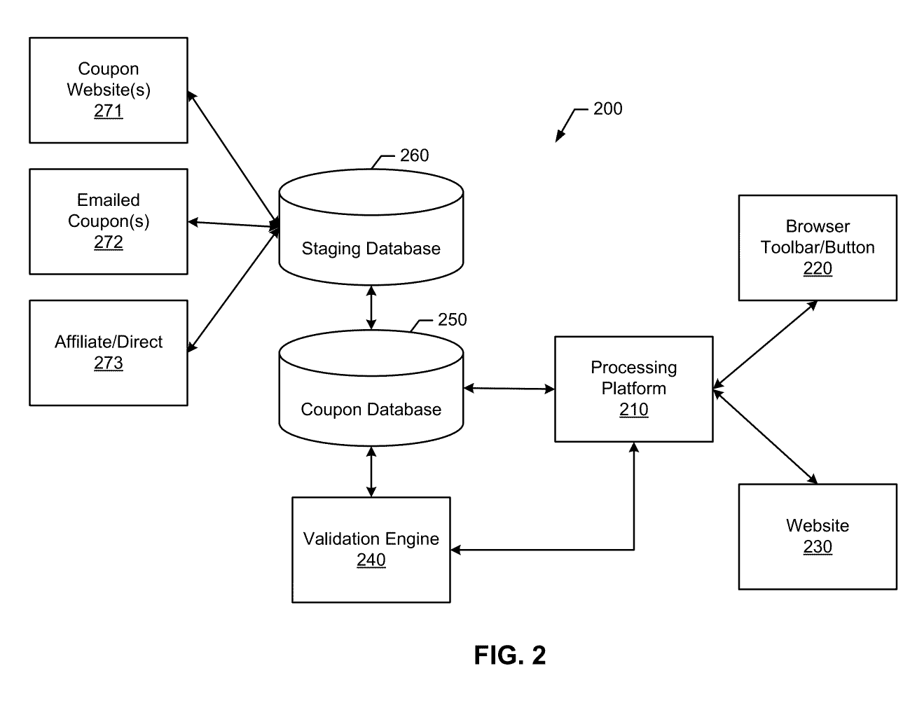

FIG. 2 illustrates an example coupon gathering, validation and presentation system 200 to identify and validate online coupon codes. The system 200 includes a processing platform 210, including a processor and a memory, which generates requests for validation (e.g., batch, “real-time”, or substantially real-time requests for validation) of coupon codes based on user activity, new retailer traffic, etc.

The processing platform 210 provides information to a browser button or tool bar 220 (e.g., a bookmarklet, browser plugin, etc.) and/or a website 230, for example. For example, the browser button or toolbar 220 can show relevant coupon code(s) based on a website a user of the browser is currently browsing. If the webpage is a shopping cart page, most appropriate coupon(s) are highlighted and/or otherwise prioritized, for example. Via the website 230, the platform 210 can provide a searchable listing with category(-ies) based on retailer, type of product, popularity, etc. The processing platform 210 can be triggered automatically based on website 230, manually based on user selection of the browser button/toolbar 220, etc.

In certain examples, the processing platform 210 batches or provides (e.g., periodically, real-time, substantially real-time, etc.) requests for validation to a validation engine 240 based on user activity, retailer traffic, etc. The validation engine 240 queries one or more coupon databases 250, which can in turn interact with one or more staging databases 260, for example. The validation engine 240 identifies and verifies an expiration date, for example. The validation engine 240 provides “live” validity testing as well as source-specific testing logic, for example.

The staging database 260 references one or more coupon sources 270 such as coupon websites 271, emailed coupons 272, affiliate/direct coupon information 273, etc. The staging database 260 organizes and processes information collected from the one or more coupon sources 270, for example. For example, the staging database 260 can process collected coupon code information to clean, parse, remove duplicates, etc., before providing the coupon code information to the coupon database 250.

The validation engine 240 retrieves the coupon code information from the coupon database 250 and validates one or more relevant coupon codes for the item, site, merchant, etc., associated with a website currently being viewed by the user. The processing platform 210 collects and formats coupon code results from the validation engine 240 and displays the results via the browser to the user. The results may be displayed via a results interface in conjunction with the webpage 230 being viewed, for example. The results may be displayed as part of the webpage 230 being viewed, for example. The results may be displayed via a results interface separate from the webpage 230, for example.

In certain examples, the validation engine 240 validates a coupon code by conducting a test transaction using that coupon code. For example, the validation engine 240 can apply the coupon code in connection with an item of interest at a merchant website.

The validation engine 240 can receive a request or other trigger for coupon code(s) related to a website, vendor and/or item, for example. The request or trigger can result from user viewing of a website and/or specific item on the website, for example. One or more coupon codes can be retrieved via a database 250, for example.

The validation engine 240 accesses the coupon database 250 to retrieve one or more coupon codes based on one or more search criterion (e.g., merchant, item, type/category, etc.). The validation engine 240 then accesses a vendor website to test the coupon code(s). For example, the validation engine 240 selects an item on the website and initiates a purchase of the item (e.g., by selecting and adding the item to a shopping cart for the website. The validation engine 240 notes a price for the item in the shopping cart. The price can include shipping, tax, handling charge, etc.

At checkout, the validation engine 240 provides a selected coupon code and applies it to the item being purchased. The validation engine 240 then monitors the transaction to determine whether the price for the item in the shopping cart (e.g., including shipping, handling, tax, etc.) has changed. Based on the change in price, the validation engine 240 can determine whether the coupon code is valid, is valid and applicable to the particular item, etc. The validation engine 240 can repeat the validation for one or more additional coupon codes. The validation engine 240 can then provide an output to the user (e.g., via the website 230) based on valid, applicable coupon code(s).

Example Coupon Code Identification and Validation Methods

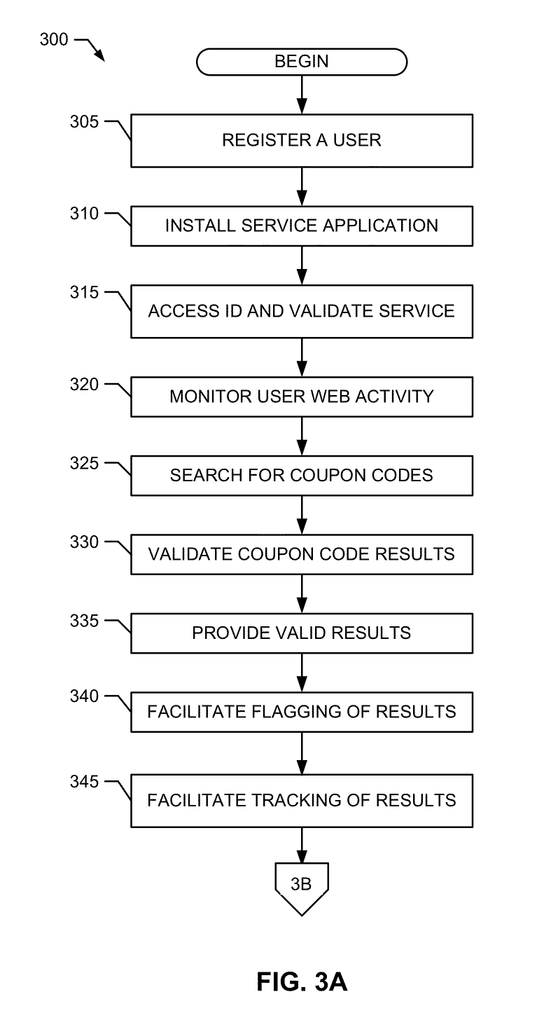

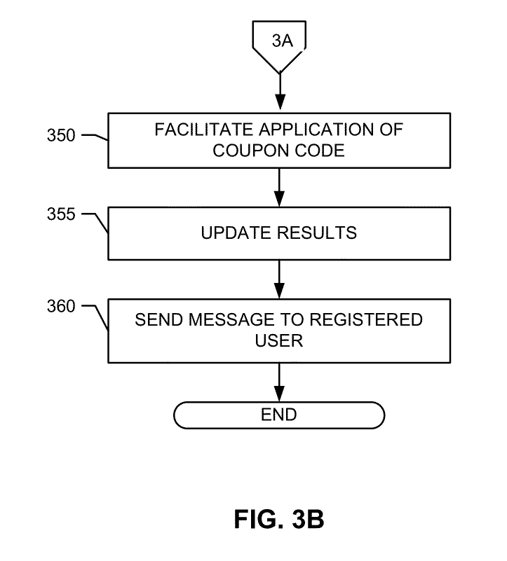

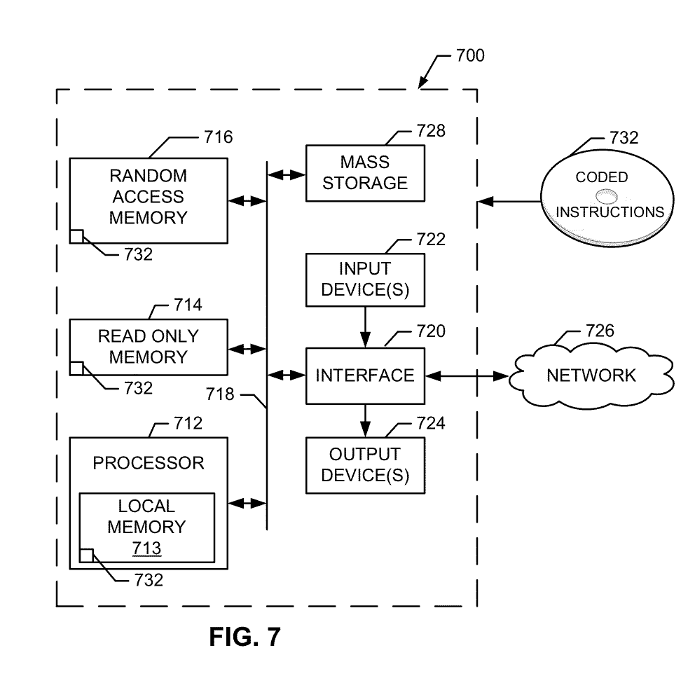

A flowchart representative of example machine readable instructions for implementing systems 100, 200 of FIGS. 1-2 is shown in FIG. 3. In this example, the machine readable instructions comprise a program for execution by a processor such as the processor 712 shown in the example computer 700 discussed below in connection with FIG. 7. The program may be embodied in software stored on a tangible computer readable medium such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIG. 3, many other methods of implementing the example system 100, 200 may alternatively be used. For example, the order of execution of the blocks may be changed, and/or some of the blocks described may be changed, eliminated, or combined.

FIG. 3 illustrates a flow diagram of an example method 300 to provide coupon codes to a user. At block 305, a user registers with a coupon identification and validation service. For example, the user establishes a login and password and may provide additional identifying information such as birth date, location (e.g., zip code, state, city, etc.), vendor preferences (e.g., frequent or favorite merchants and/or websites, vendor types, etc.), item preferences (e.g., item types, item sources, item names, etc.), format preferences (e.g., number of coupon results, flagging preferences, webpage format, etc.), etc. Registration can involve a user's agreement to monitoring, recording, and/or analyzing of certain information, habits, shopping, etc., as well as installation of a monitor and/or other application related to the service, for example.

At block 310, the user installs an identification and validation service application. For example, the user drags and drops a bookmarklet on to his or her browser to enable coupon identification and validation service functionality via the browser. The bookmarklet then becomes a part of the browser functionality. In certain examples, the application can be installed as a separate application on the user's computer. In certain examples, the application can be installed without user registration.

At block 315, the user logs in to the coupon identification and validation service. For example, the user enters a username and password, email address, etc., to access the identification and validation service functionality via a website. In certain examples, the user may not need to log in to the service but may instead simply activate the bookmarklet or other local application to initiate coupon code search and verification.

At block 320, the service identifies a website being visited by the user. For example, the service identifies, based on an installed service application, browser cookies, etc., the website being viewed. In certain examples, the website can be identified based on user selection or other activation or triggering of the service application (e.g., bookmarklet, browser plugin, etc.). For example, the user accesses a merchant website, such as an electronics website, and reviews an item (e.g., a game system) on the website.

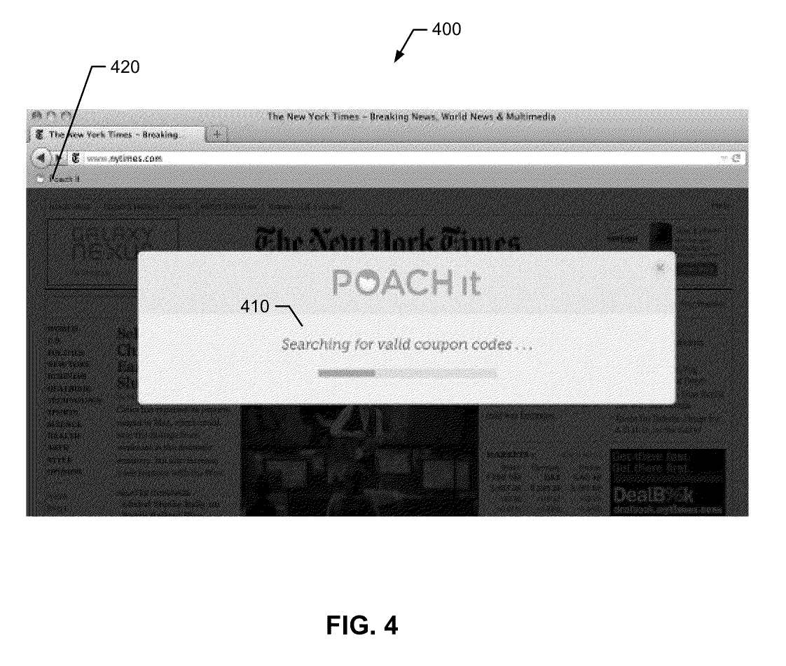

At block 325, the service searches for applicable coupon code(s). For example, the service searches for applicable coupon codes based on user selection of the installed bookmarklet via the user's web browser. For example, coupon codes can be searched for a general website, a particular product page, etc. FIG. 4 illustrates an example interface 400 indicating a search for valid coupon codes 410 based on user initiation via a browser bookmarklet 420.

At block 330, coupon code results are validated. For example, coupon code candidates are identified (e.g., via spider and/or other web crawling and/or database searching, etc.) and applied by a validation program (e.g., a robot) to a relevant website (e.g., a merchant or other vendor website) to determine whether the coupon code is valid (e.g., is valid for a particular website, item, date range, category, user, etc.).

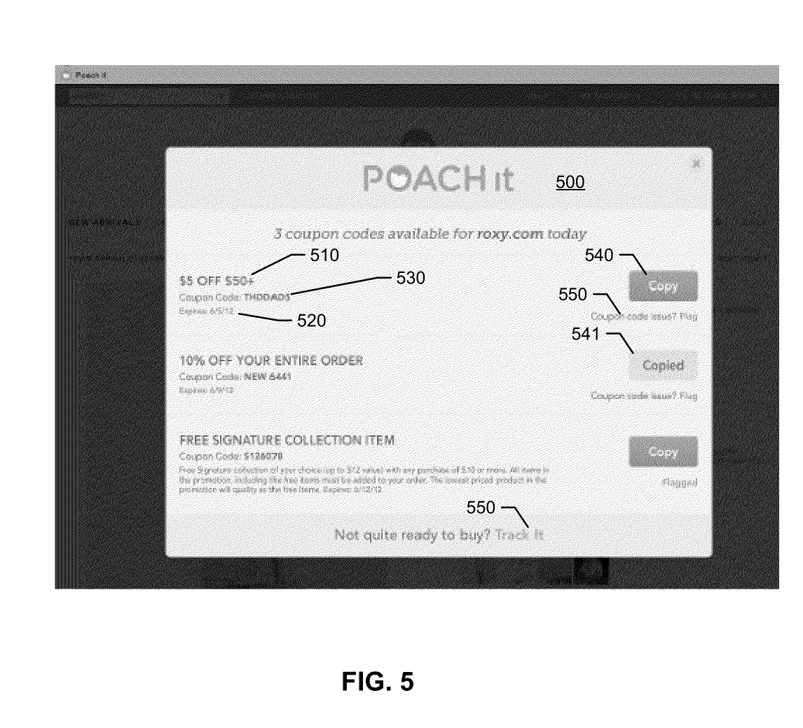

At block 335, valid, applicable coupon code results are provided to the user. For example, a results interface webpage (e.g., separate from and/or integrated with a webpage currently viewed by the user) is displayed identifying valid coupon code(s) relevant to item(s) being viewed by the user. FIG. 5 shows an example coupon code results interface 500 displayed as an overlay to a merchant website the user is currently viewing.

The example results interface webpage 500 includes a plurality of coupon codes for review and selection by a user. Each code in the example 500 includes a descriptor of a type of code 510 (e.g., five dollars ($5) off of an order of fifty dollars ($50) or more, ten percent (10%) off an order, free shipping, free item, etc.). Applicable restriction(s) for a coupon code can be displayed as well (e.g., valid only on a certain combination of items, certain category, etc.). Each code in the example 500 includes an expiration date 520, if applicable. Each code in the example 500 includes a coupon code itself 530. Using a copy button 540, a coupon code 530 can be copied for use, for example. By selecting a copy button 541, the corresponding code is copied into a buffer on a user's computer for use by the user, for example.

In certain examples, coupon code results can be displayed in a variety of ways. For example, all relevant, valid coupon codes can be shown. Results can be narrowed to only show coupon codes valid and relevant to the user, for example. Results can be narrowed to only show coupon codes valid and relevant to one or more items displayed on a webpage being viewed by the user, for example.

At block 340, one or more results can be flagged by a user. For example, as shown in FIG. 5, if a user experiences a problem or other difficulty with a coupon code (e.g., the code is expired, does not apply to an item, etc.), the user can flag 550 that code.

At block 345, one or more results can be tracked based on user selection. For example, as shown in FIG. 5, if a user is not quite ready to purchase an item, the user can select to track 560 that item and associated coupon(s). For example, if the user is on the product webpage, the user can selected to “Track It”, to display the product information and track the product. In certain examples, a user can send a product link to a tracking inbox to have a service track the product. In certain examples, a follow-up email or other message (e.g., an SMS or MMS message) can be sent to the user based on a price drop, coupon availability, discount, etc.

At block 350, copying and/or other application of a coupon code is facilitated. For example, as shown in FIG. 5, selection of the copy button 540, 541 results in the coupon code being copied and available for pasting by the user into a coupon code field of a merchant website to purchase an item.

At block 355, results can be updated. For example, a website can be added to a coupon database for further review. Coupon code search results can be updated based on a user's web browsing location, for example.

At block 360, a message can be sent to a registered user. For example, an email, newsletter, and/or other message can be provided to a registered user with updates, new coupon code(s), price drops, discounts, etc. Updates can be tailored to a particular user or group of users or provided generally to all registered users, for example.

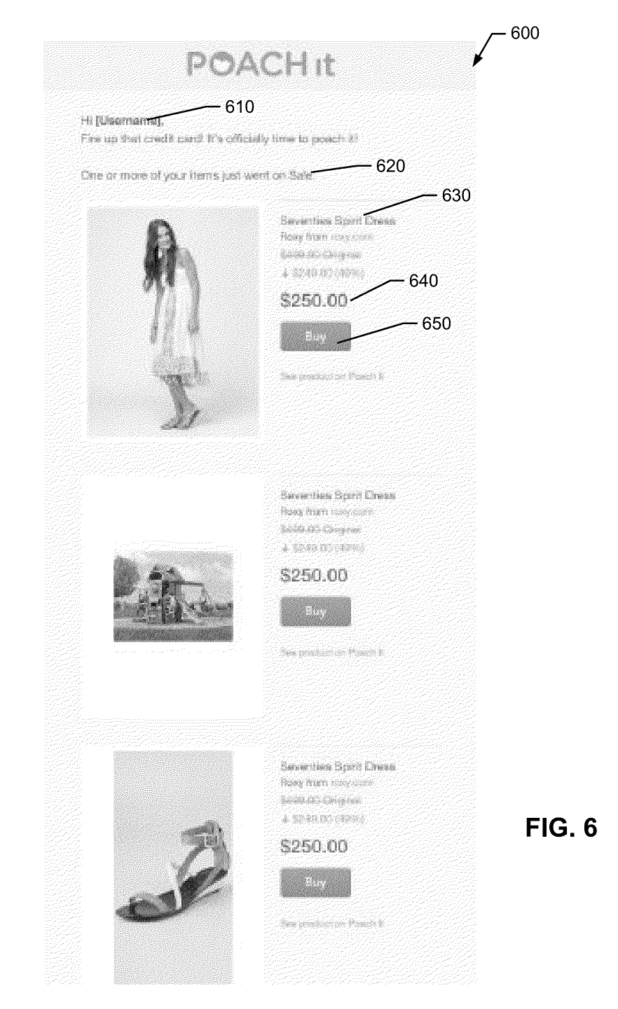

FIG. 6 shows an example email message 600 including one or more item updates for a registered user 610. The example message 600 alerts the user 610 to an event or status change 620, such as a sale. The example message 600 includes one or more item updates, such as item sales, based on, for example, item(s) that the user has tracked in prior sessions. For each item, the example message 600 provides an item description 630 (e.g., text, picture, video, etc.), a price 640, and a button or other link 650 to purchase the item, for example. The example message 600 can include or more coupon codes and/or link(s) to coupon codes, for example. Alternatively or in addition, selection to purchase 650 an item can trigger coupon code identification and validation, as described above.

As illustrated in the example of FIG. 6, the message 600 can include a list of tracked products with an option to buy. In certain examples, all tracked items can be incorporated in a single email, or a separate email can be sent for each vendor and/or product type being tracked. In certain examples, separate messages can be sent for in-stock items, out-of-stock items, etc.

While an example manner of implementing the systems 100, 200 of FIGS. 1-2 has been illustrated in FIGS. 4-6, one or more of the elements, processes and/or devices illustrated in FIGS. 1-6 may be combined, divided, re-arranged, omitted, eliminated and/or implemented in any other way. Further, example components and example methods may be implemented by hardware, software, firmware and/or any combination of hardware, software and/or firmware. Thus, for example, any of the example elements of the systems and methods described herein can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the system claim of this patent are read to cover a purely software and/or firmware implementation, at least one of the example components is hereby expressly defined to include a tangible computer readable medium such as a memory, DVD, CD, Blu-ray, etc. storing the software and/or firmware. Further still, the example systems 100, 200 and methods 300 of FIGS. 1-3 may include one or more elements, processes and/or devices in addition to, or instead of, those illustrated in FIGS. 1-3, and/or may include more than one of any or all of the illustrated elements, processes and devices.

As mentioned above, the example processes of FIG. 3 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 3 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 7 is a block diagram of an example computer 700 capable of executing the instructions of FIG. 3 to implement the systems of FIGS. 1-2 and 4-6. The computer 700 can be, for example, a server, a personal computer, a mobile phone (e.g., a cell phone), a personal digital assistant (PDA), an Internet appliance, a DVD player, a CD player, a digital video recorder, a Blu-ray player, a gaming console, a personal video recorder, a set top box, or any other type of computing device.

The system 700 of the instant example includes a processor 712. For example, the processor 712 can be implemented by one or more microprocessors or controllers from any desired family or manufacturer.

The processor 712 includes a local memory 713 (e.g., a cache) and is in communication with a main memory including a volatile memory 716 and a non-volatile memory 714 via a bus 718. The volatile memory 716 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 714 may be implemented by flash memory and/or any other desired type of memory device. Access to the main memory 714, 716 is controlled by a memory controller.

The computer 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), a printer and/or speakers). The interface circuit 720, thus, typically includes a graphics driver card.

The interface circuit 720 also includes a communication device such as a modem or network interface card to facilitate exchange of data with external computers via a network 726 (e.g., an Ethernet connection, a digital subscriber line (DSL), a telephone line, coaxial cable, a cellular telephone system, etc.).

The computer 700 also includes one or more mass storage devices 728 for storing software and data. Examples of such mass storage devices 728 include floppy disk drives, hard drive disks, compact disk drives and digital versatile disk (DVD) drives. The mass storage device 728 may implement the example database(s) and/or other storage provided herein, for example.

The coded instructions 732 of FIG. 3 may be stored in the mass storage device 728, in the volatile memory 714, in the non-volatile memory 716, and/or on a removable storage medium such as a CD or DVD.

From the foregoing, it will appreciate that the above disclosed methods and systems provide coupon codes to online shoppers. The above disclosed methods and systems help ensure that only valid, relevant coupon codes are provided to users.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A system comprising:
a processor to receive a trigger to initiate a coupon code query based at least in part on a website being viewed; and
a validation engine to search and retrieve coupon codes, the validation engine to apply one or more identified coupon codes to a target website to determine validity of each identified coupon code,
wherein the processor is to dynamically provide one or more validated coupon codes to a user in conjunction with the website being viewed.

2. The system of claim 1, wherein the trigger comprises a user-selected trigger.

3. The system of claim 2, wherein the system further comprises a bookmarklet installed with respect to a web browser, and wherein the trigger comprises a user selection of the bookmarklet while viewing the website.

4. The system of claim 1, wherein the processor is to dynamically provide one or more validated coupon codes relevant to a merchant associated with the website being viewed.

5. The system of claim 1, wherein the processor is to dynamically provide one or more validated coupon codes relevant to an item associated with the website being viewed.

6. The system of claim 1, wherein the processor is to dynamically provide one or more validated coupon codes via a results interface, the results interface to facilitate selection and copying of a coupon code to be applied to the website.

7. The system of claim 6, wherein the results interface is to facilitate tracking of one or more items associated with a displayed coupon code.

8. The system of claim 7, wherein the processor is to generate a message to the user with an update regarding one or more tracked items.

9. The system of claim 6, wherein the results interface is to facilitate flagging of a displayed coupon code to indicate a problem with the coupon code.

10. A method comprising:
initiating, based on a trigger, a coupon code query based at least in part on a website being viewed;
searching for and retrieving one or more coupon codes using a processor;
applying, using the processor without further user input, one or more identified coupon codes to a target website to determine validity of each identified coupon code;
dynamically providing one or more validated coupon codes to a user in conjunction with the website being viewed; and
facilitating selection of a validated coupon code to be used with respect to the website being viewed.

11. The method of claim 10, wherein the trigger comprises a user-selected trigger.

12. The method of claim 11, further comprising facilitating installation of a bookmarklet with respect to a web browser, wherein the trigger comprises a user selection of the bookmarklet while viewing the website.

13. The method of claim 10, wherein dynamically providing further comprises dynamically providing one or more validated coupon codes relevant to a merchant associated with the website being viewed.

14. The method of claim 10, wherein dynamically providing further comprises dynamically providing one or more validated coupon codes relevant to an item associated with the website being viewed.

15. The method of claim 10, further comprising facilitating tracking of one or more items associated with a displayed coupon code.

16. The method of claim 15, further comprising generating, using the processor, a message to the user with an update regarding one or more tracked items.

17. The method of claim 10, further comprising facilitating flagging of a displayed coupon code to indicate a problem with the coupon code.

18. A tangible computer-readable storage medium including computer program instructions which, when executed by a processor, are to implement a method comprising:
initiating, based on a trigger, a coupon code query based at least in part on a website being viewed;
searching for and retrieving one or more coupon codes using the processor;
applying, using the processor without further user input, one or more identified coupon codes to a target website to determine validity of each identified coupon code;
dynamically providing one or more validated coupon codes to a user in conjunction with the website being viewed; and
facilitating selection of a validated coupon code to be used with respect to the website being viewed.

19. The computer-readable medium of claim 18, wherein the method further comprises facilitating installation of a bookmarklet with respect to a web browser, wherein the trigger comprises a user selection of the bookmarklet while viewing the website.

20. The method of claim 18, wherein dynamically providing further comprises dynamically providing one or more validated coupon codes relevant to at least one of merchant and an item associated with the website being viewed.
